(19) United States
(12) Patent Application Publication
(10) Pub. No.: US 2023/0123788 A1
(43) Pub. Date: Apr. 20, 2023

(54) VEHICLE TRAVELING CONTROL DEVICE AND VEHICLE TRAVELING CONTROL METHOD

(71) Applicant: TOYOTA JIDOSHA KABUSHIKI KAISHA, Toyota-shi Aichi-ken (JP)

(72) Inventor: Daiki Yamamoto, Susono-shi Shizuoka-ken (JP)

(73) Assignee: TOYOTA JIDOSHA KABUSHIKI KAISHA, Toyota-shi Aichi-ken (JP)

(21) Appl. No.: 17/955,048

(22) Filed: Sep. 28, 2022

(30) Foreign Application Priority Data
Oct. 20, 2021 (JP) 2021-171519

(51) Int. Cl. B60W 30/16; B60W 40/04; B60W 40/105

(52) U.S. Cl. CPC B60W 30/16; B60W 40/04; B60W 40/105; B60W 2754/30; B60W 2554/4041; B60W 2554/801; B60W 2552/10; B60W 2554/4043; B60W 2520/10; B60W 2720/10; B60W 2554/4045

(57) ABSTRACT

The vehicle traveling control device performs control to secure the vehicle-to-vehicle distance between the preceding vehicle and the own vehicle when the lateral position of the preceding vehicle traveling in the adjacent lane reaches the reference lateral position. The vehicle traveling control device includes a speed calculating unit that calculates a relative lateral speed of the preceding vehicle with respect to the own vehicle, a reference position setting unit that sets a reference lateral position based on the relative lateral speed, and a vehicle control unit that controls the traveling of the own vehicle when the preceding vehicle reaches the reference lateral position. The reference position setting unit sets the reference lateral position to the side farther from the own vehicle as the relative lateral speed is smaller.

### CROSS-REFERENCE TO RELATED APPLICATION

This application claims priority to Japanese Patent Application No. 2021-171519 filed on Oct. 20, 2021, incorporated herein by reference in its entirety.

### BACKGROUND

### 1. Technical Field

The present disclosure relates to a vehicle traveling control device and a vehicle traveling control method.

### 2. Description of Related Art

For example, a preceding vehicle traveling in an adjacent lane may cut in front of an own vehicle by making a lane change. For example, Japanese Unexamined Patent Application Publication No. 2016-134093 (JP 2016-134093 A) describes that determination of whether such a preceding vehicle cuts in front of an own vehicle is made. A device described in JP 2016-134093 A determines whether the preceding vehicles cuts in front of the own vehicle based on a relative lateral position of the preceding vehicle relative to the own vehicle in a lateral direction.

### SUMMARY

In the device described in JP 2016-134093 A, a relative lateral speed of the preceding vehicle is not considered when determination of whether a preceding vehicle cuts in front of an own vehicle is made. Therefore, when a case where the relative lateral speed of the preceding vehicle is large and a case where the relative lateral speed is small are compared, the time required for the preceding vehicle to reach a relative lateral position used for determining whether the preceding vehicle cuts in front of the own vehicle is longer when the relative lateral speed is small. Thus, when the relative lateral speed is small, a vehicle-to-vehicle distance between the preceding vehicle and the own vehicle is already close when determination is made that the preceding vehicle cuts in front of the own vehicle. Therefore, even when deceleration control for securing the vehicle-to-vehicle distance is performed based on such determination, there is a possibility that the deceleration control cannot be performed at an appropriate timing.

For this reason, the present disclosure provides a vehicle traveling control device and a vehicle traveling control method capable of performing control for securing the vehicle-to-vehicle distance at an appropriate timing based on a traveling state of the preceding vehicle.

One aspect of the present disclosure is a vehicle traveling control device that performs control for securing a vehicle-to-vehicle distance between a preceding vehicle and an own vehicle when a lateral position of the preceding vehicle traveling in an adjacent lane of the own lane in which the own vehicle travels moves toward the own lane side and the preceding vehicle reaches a predetermined reference lateral position. The vehicle traveling control device includes

a speed calculating unit for calculating a lateral speed of the preceding vehicle in a lane lateral direction or a relative lateral speed of the preceding vehicle relative to the own vehicle in the lane lateral direction,
a reference position setting unit for setting the reference lateral position based on the lateral speed or the relative lateral speed calculated by the speed calculating unit, and
a vehicle control unit for controlling traveling of the own vehicle such that the vehicle-to-vehicle distance between the preceding vehicle and the own vehicle in a lane longitudinal direction is secured when the preceding vehicle reaches the reference lateral position.
The reference position setting unit sets the reference lateral position to a side farther from the own vehicle in the lane lateral direction as the lateral speed is lower or the relative lateral speed is smaller.

In this vehicle traveling control device, the reference lateral position to the farther from the own vehicle as the lateral speed is lower or the relative lateral speed is smaller. That is, it is determined that the preceding vehicle has reached the reference lateral position at an early stage when a movement amount of the preceding vehicle toward the own lane side is small as the lateral speed is lower or the relative lateral speed is smaller. Thus, even when the relative lateral speed is small, it is possible to suppress the situation in which the vehicle-to-vehicle distance between the preceding vehicle and the own vehicle is close when it is determined that the preceding vehicle cuts in front of the own vehicle. As described above, the vehicle traveling control device can determine at an appropriate timing that the preceding vehicle has reached the reference lateral position based on the lateral speed or the lateral relative speed of the preceding vehicle. Therefore, by using this determination result, the vehicle traveling control device can perform control for securing the vehicle-to-vehicle distance at an appropriate timing based on the traveling state of the preceding vehicle.

In the vehicle traveling control device, the speed calculating unit may further calculate a speed of the own vehicle in the lane longitudinal direction or a relative speed of the preceding vehicle relative to the own vehicle in the lane longitudinal direction. The reference position setting unit may set the reference lateral position to the side farther from the own vehicle in the lane lateral direction as the speed of the own vehicle in the lane longitudinal direction calculated by the speed calculating unit is higher or as the relative speed of the preceding vehicle relative to the own vehicle in the lane longitudinal direction is smaller.

In this case, it is determined that the preceding vehicle has reached the reference lateral position at an early stage when the movement amount of the preceding vehicle toward the own lane side is small as the own vehicle approaches the preceding vehicle early. As a result, the vehicle traveling control device can determine at a more appropriate timing that the preceding vehicle has reached the reference lateral position in consideration of the speed of the own vehicle or the relative speed with the preceding vehicle in the lane longitudinal direction. Then, based on the determination result, the vehicle traveling control device can perform control for securing the vehicle-to-vehicle distance at a more appropriate timing.

In the vehicle traveling control device, the vehicle control unit may perform control for decelerating the own vehicle such that the vehicle-to-vehicle distance between the preceding vehicle and the own vehicle in the lane longitudinal direction is secured. In this case, the vehicle traveling control device can secure the vehicle-to-vehicle distance between the preceding vehicle and the own vehicle more reliably.

In the vehicle traveling control device, the vehicle control unit may set a deceleration amount of the own vehicle based on the vehicle-to-vehicle di stance between the own vehicle and the preceding vehicle in the lane longitudinal direction or the relative speed between the own vehicle and the preceding vehicle in the lane longitudinal direction, and decelerate the own vehicle based on the set deceleration amount.

In this case, the vehicle traveling control device can decelerate the own vehicle more appropriately in accordance with the vehicle-to-vehicle distance between the own vehicle and the preceding vehicle or the relative speed.

The vehicle traveling control device may further include a turn signal determination unit for determining whether a turn signal of the preceding vehicle is operated. The reference position setting unit may set the reference lateral position on a lane separation line for separating the own lane and the adjacent lane when the turn signal determination unit determines that the turn signal of the preceding vehicle is not operated.

For example, when the turn signal of the preceding vehicle is not operated, it is considered that the preceding vehicle (a driver of the preceding vehicle) does not have an intention to make a lane change. For this reason, it is considered that the preceding vehicle merely wobbles when the lateral position of the preceding vehicle approaches the own lane side while the turn signal is not operated. Therefore, the vehicle traveling control device sets the reference lateral position on the lane separation line when the turn signal of the preceding vehicle is not operated. Thus, the vehicle traveling control device can suppress early determination in which the preceding vehicle cuts in front of the own vehicle (early determination in which the preceding vehicle reaches the reference lateral position) just because the preceding vehicle merely wobbles. Therefore, in the vehicle traveling control device, it is possible to control traveling of the own vehicle more appropriately in accordance with the traveling state of the preceding vehicle.

Another aspect of the present disclosure is a vehicle traveling control method executed in a vehicle traveling control device that performs control for securing a vehicle-to-vehicle distance between a preceding vehicle and an own vehicle when a lateral position of the preceding vehicle traveling in an adjacent lane of an own lane in which the own vehicle travels moves toward the own lane side and the preceding vehicle reaches a predetermined reference lateral position. The vehicle traveling control method includes a speed calculation step of calculating a lateral speed of the preceding vehicle in a lane lateral direction or a relative lateral speed of the preceding vehicle relative to the own vehicle in the lane lateral direction,

a reference position setting step of setting the reference lateral position based on the lateral speed or the relative lateral speed calculated in the speed calculation step, and
a vehicle control step of controlling traveling of the own vehicle such that the vehicle-to-vehicle distance between the preceding vehicle and the own vehicle in a lane longitudinal direction is secured when the preceding vehicle reaches the reference lateral position.
In the reference position setting step, the reference lateral position is set to a side farther from the own vehicle in the lane lateral direction as the lateral speed is lower or the relative lateral speed is smaller.

In this vehicle traveling control method, the reference lateral position is set to the side farther from the own vehicle as the lateral speed is lower or the relative lateral speed is smaller. That is, it is determined that the preceding vehicle has reached the reference lateral position at an early stage when a movement amount of the preceding vehicle toward the own lane side is small as the lateral speed is lower or the relative lateral speed is smaller. Thus, even when the relative lateral speed is small, it is possible to suppress the situation in which the vehicle-to-vehicle distance between the preceding vehicle and the own vehicle is close when it is determined that the preceding vehicle cuts in front of the own vehicle. Thus, in the vehicle traveling control method, based on the lateral speed or the lateral relative speed of the preceding vehicle, it is possible to determine at an appropriate timing that the preceding vehicle has reached the reference lateral position. Therefore, by using this determination result, in the vehicle traveling control method, it is possible to perform control for securing the vehicle-to-vehicle distance at an appropriate timing based on the traveling state of the preceding vehicle.

In the vehicle traveling control method, in the speed calculation step, a speed of the own vehicle in the lane longitudinal direction or a relative speed of the preceding vehicle relative to the own vehicle in the lane longitudinal direction may be further calculated. In the reference position setting step, the reference lateral position may be set to the side farther from the own vehicle in the lane lateral direction as the speed of the own vehicle in the lane longitudinal direction calculated in the speed calculation step is higher or as the relative speed of the preceding vehicle relative to the own vehicle in the lane longitudinal direction is smaller.

In this case, it is determined that the preceding vehicle has reached the reference lateral position at an early stage when the movement amount of the preceding vehicle toward the own lane side is small as the own vehicle approaches the preceding vehicle early. Thus, in the vehicle traveling control method, it is possible to determine at a more appropriate timing that the preceding vehicle has reached the reference lateral position in consideration of the speed of the own vehicle or the relative speed with the preceding vehicle in the lane longitudinal direction. Then, based on the determination result, in the vehicle traveling control method, it is possible to perform control for securing the vehicle-to-vehicle distance at a more appropriate timing.

In the vehicle traveling control method, in the vehicle control step, control for decelerating the own vehicle may be performed such that the vehicle-to-vehicle distance between the preceding vehicle and the own vehicle in the lane longitudinal direction is secured.

In this case, in the vehicle traveling control method, it is possible to secure the vehicle-to-vehicle distance between the own vehicle and the preceding vehicle more reliably.

In the vehicle traveling control method, in the vehicle control step, a deceleration amount of the own vehicle may be set based on the vehicle-to-vehicle distance between the own vehicle and the preceding vehicle in the lane longitudinal direction or the relative speed between the own vehicle and the preceding vehicle in the lane longitudinal direction, and the own vehicle may be decelerated based on the set deceleration amount.

In this case, in the vehicle traveling control method, it is possible to decelerate the own vehicle more appropriately in accordance with the vehicle-to-vehicle distance between the own vehicle and the preceding vehicle or the relative speed.

The vehicle traveling control method may further include a turn signal determination step of determining whether a turn signal of the preceding vehicle is operated. In the reference position setting step, the reference lateral position may be set on a lane separation line for separating the own lane and the adjacent lane when determination is made in the turn signal determination step that the turn signal of the preceding vehicle is not operated.

For example, when the turn signal of the preceding vehicle is not operated, it is considered that the preceding vehicle (a driver of the preceding vehicle) does not have an intention to make a lane change. For this reason, it is considered that the preceding vehicle merely wobbles when the lateral position of the preceding vehicle approaches the own lane side while the turn signal is not operated. Therefore, in the vehicle traveling control method, the reference lateral position is set on the lane separation line when the turn signal of the preceding vehicle is not operated. Thus, the vehicle traveling control method can suppress early determination in which the preceding vehicle cuts in front of the own vehicle (early determination in which the preceding vehicle reaches the reference lateral position) just because the preceding vehicle merely wobbles. Therefore, in the vehicle traveling control method, it is possible to control traveling of the own vehicle more appropriately in accordance with the traveling state of the preceding vehicle.

According to various aspects of the present disclosure, it is possible to perform control for securing the vehicle-to-vehicle distance at an appropriate timing based on the traveling state of the preceding vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a vehicle traveling control device according to an embodiment;

FIG. 2 is a diagram for explaining a situation in which the vehicle traveling control device controls the traveling of the vehicle and a reference lateral position to be set;

FIG. 3 is a diagram showing the relative speed of the relative lateral speed and the lane longitudinal direction, the relationship between the reference lateral positions;

FIG. 4 is a flowchart illustrating a flow of processing of a vehicle traveling control method executed by a vehicle traveling control device;

FIG. 5 is a block diagram showing an example of a vehicle traveling control device according to a modification;

FIG. 6A is a diagram for explaining a condition in which a vehicle traveling control device controls the traveling of the own vehicle and a reference lateral position to be set;

FIG. 6B is a diagram for explaining a condition in which a vehicle traveling control device controls the traveling of the own vehicle and a reference lateral position to be set; and

FIG. 7 is a flowchart illustrating a flow of processing of a vehicle traveling control method executed by a vehicle traveling control device.

### DETAILED DESCRIPTION OF EMBODIMENTS

Exemplary embodiments will be described below with reference to the drawings. In the drawings, the same or corresponding elements are denoted by the same reference numerals, and a repetitive description thereof is omitted.

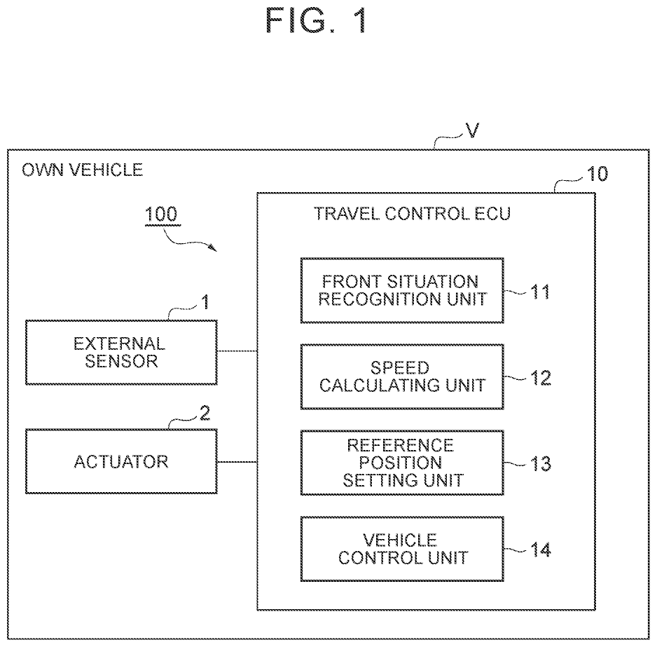

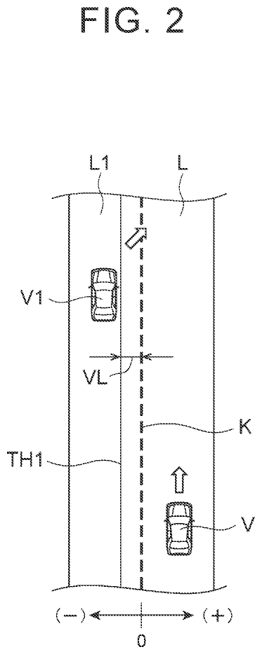

As shown in FIG. 1, the vehicle traveling control device 100 controls the traveling of the own vehicle V. The vehicle traveling control device 100 in the present embodiment, as shown in FIG. 2, the lateral position of the preceding vehicle V1 traveling in the adjacent lane L1 moves toward the own lane L side, determines whether or not the preceding vehicle V1 has reached the predetermined reference lateral position TH1. In other words, the vehicle traveling control device 100 determines whether or not the preceding vehicle V1 traveling in the adjacent lane L1 is interrupted in front of the own vehicle V. Then, the vehicle traveling control device 100, when the preceding vehicle V1 reaches a predetermined reference lateral position TH1, it is determined that the preceding vehicle V1 is interrupted in front of the own vehicle V. Then, the vehicle traveling control device 100 performs control to secure the vehicle-to-vehicle distance between the preceding vehicle V1 and the own vehicle V.

The adjacent lane L1 is a lane adjacent to the own lane L on which the own vehicle V runs. In the example shown in FIG. 2, the adjacent lane L1 exists on the left side of the own lane L, but the adjacent lane L1 may exist on the right side of the own lane L. Further, in the present embodiment, a case will be described in which the own vehicle V overtakes the preceding vehicle V1 (that is, when the speed of the own vehicle V is faster than the preceding vehicle V1). However, even in the case where the speed of the preceding vehicle V1 is higher than the own vehicle V, the vehicle traveling control device 100 may perform the processing described below.

As shown in FIG. 1, the vehicle traveling control device 100 includes an external sensor 1, an actuator 2, and a travel control electronic control unit (ECU) 10.

External sensor 1 is a detection device for detecting the external environment of the own vehicle V. The external sensor 1 includes at least one of a camera and a radar sensor.

The camera is an imaging device for imaging the external environment of the own vehicle V. The camera is provided on the rear side of the windshield of the own vehicle V. The camera images the front of the vehicle. The camera transmits the imaging information about the external environment of the own vehicle V to the travel control ECU 10. The camera may be a monocular camera or a stereo camera.

The radar sensor is a detection device for detecting an object around the own vehicle V by utilizing radio waves (e.g., millimeter waves) or light. Radar sensors include, for example, millimeter-wave radars or Light Detection and Ranging (LIDAR). The radar sensor detects an object by transmitting radio waves or light to the periphery of its own vehicle V and receiving radio waves or light reflected by the object. The radar sensor transmits the detected object data to the travel control ECU 10. The object includes other vehicles and the like.

The actuator 2 is a device used for controlling the running of the own vehicle V. The actuator 2 includes at least a drive actuator, a brake actuator, and a steering actuator. The drive actuator controls the quantity of air supplied to the engine (throttle opening) in response to a control signal from the travel control ECU 10. The drive actuator controls the driving force of the own vehicle V. Incidentally, when the own vehicle V is a hybrid electric vehicle, in addition to the supply amount of air to the engine, a control signal from the travel control ECU 10 to the motor as a power source is input to the driving force is controlled. When the own vehicle V is a battery electric vehicle, the driving force is controlled by inputting a control signal from the travel control ECU 10 to the motor as a power source. The motor as a power source in these cases constitutes an actuator 2.

The brake actuator controls the brake system in response to a control signal from the travel control ECU 10 to control the braking force applied to the wheels of the own vehicle V. As the brake system, for example, a hydraulic brake system can be used. The steering actuator controls the drive of the assist motor for controlling the steering torque among the electric power steering systems in accordance with the control signal from the travel control ECU 10. Thus, the steering actuator controls the steering torque of the own vehicle V.

The travel control ECU 10 is an electronic control unit including a central processing unit (CPU), a read only memory (ROM), a random access memory (RAM), and the like. In the travel control ECU 10, for example, a program stored in the ROM is loaded into the RAM, and various functions are realized by executing a program loaded into the RAM by the CPU. The travel control ECU 10 may comprise a plurality of electronic units.

The travel control ECU 10 controls the traveling of the own vehicle V by giving an instruction to the actuator 2. The travel control ECU 10 functionally includes a front situation recognition unit 11, a speed calculating unit 12, a reference position setting unit 13, and a vehicle control unit 14.

The front situation recognition unit 11 recognizes the situation in front of the own vehicle V. More specifically, the front situation recognition unit 11 recognizes the preceding vehicle V1 traveling in front of the adjacent lane L1 and the own vehicle V. The front situation recognition unit 11 recognizes the vehicle existing in the adjacent lane L1 as the preceding vehicle V1 using well-known techniques, for example, based on the detection result of the external sensor 1. Further, the front situation recognition unit 11 recognizes a lane separation line (white line) that separates the own lane L and the adjacent lane L1. Front situation recognition unit 11, for example, can recognize the lane separation line K based on the captured image of the camera provided as an external sensor 1.

The speed calculating unit 12 calculates a relative lateral speed that is the speed of the preceding vehicle V1 in the lane lateral direction (the lane width direction of the own lane L and the adjacent lane L1) with respect to the own vehicle V. The relative lateral speed is the speed of the own vehicle V in the transverse direction of the lane when the own vehicle V is used as a reference. The relative lateral speed is obtained by subtracting the speed of the own vehicle V in the lane lateral direction from the speed of the preceding vehicle V1 in the lane lateral direction. Here, the speed calculating unit 12 calculates the relative lateral speed on the side where the preceding vehicle V1 comes toward the own vehicle V as the positive (plus) side. That is, the smaller the value of the relative lateral speed, the slower the speed at which the preceding vehicle V1 comes toward the own vehicle V. The speed calculating unit 12 can calculate the relative lateral speed based on a well-known technique based on, for example, the detection result of the external sensor 1.

Further, the speed calculating unit 12 calculates the relative speed of the longitudinal direction of the preceding vehicle V1 (the extending direction of the own lane L and the adjacent lane L1) with respect to the own vehicle V. The relative speed in the longitudinal direction of the lane of the preceding vehicle V1 with respect to the own vehicle V is obtained by subtracting the speed in the longitudinal direction of the lane of the own vehicle V from the speed in the longitudinal direction of the lane of the preceding vehicle V1. Here, the speed calculating unit 12 calculates the relative speed on the side where the own vehicle V travels as a positive (plus) side. That is, the smaller the value of the relative speed, the closer the own vehicle V approaches the preceding vehicle V1. Further, when the relative speed is a negative value, since the speed of the own vehicle V is higher than the preceding vehicle V1, the own vehicle V approaches the preceding vehicle V1. The speed calculating unit 12, for example, based on the detection result of the external sensor 1, can calculate the relative speed in the longitudinal direction of the lane based on a well-known technique.

The reference position setting unit 13 sets the reference lateral position TH1 based on the relative lateral speed of the preceding vehicle V1 calculated by the speed calculating unit 12. The reference lateral position is a threshold value for determining whether or not the preceding vehicle V1 interrupts the front of the own vehicle V. The reference position setting unit 13 sets the reference lateral position TH1 at a predetermined position in the lane lateral direction, for example, as shown in FIG. 2.

Here, the vehicle traveling control device 100, using a predetermined coordinate system, it is possible to determine whether the preceding vehicle V1 has reached the reference lateral position TH1. Here, as an example, the vehicle traveling control device 100 may use a coordinate system in which the position where the lane separation line K is provided in the lane width direction is set as the origin (0), the own lane L side is set as the value of positive (+), and the adjacent lane L1 side is set as the value of negative (−). Hereinafter, as an example, a case of determining using this coordinate system will be described. Incidentally, the vehicle traveling control device 100 may perform determination using a coordinate system other than described here.

The reference position setting unit 13 sets the reference lateral position TH1 (sets the reference lateral position TH1) using the coordinate system with the lane separation line K as the origin. For example, the reference lateral position TH1 in FIG. 2 is set to the left side than the lane separation line K, and has a negative value.

Further, the reference position setting unit 13 sets the reference lateral position TH1 to the side farther from the preceding vehicle V1 in the lane lateral direction as the relative lateral speed calculated by the speed calculating unit 12 is smaller. Here, the reference position setting unit 13, in the coordinate system with the lane separation line K as the origin as shown in FIG. 2, as the relative lateral speed is small, sets the reference lateral position TH1 on the side (left side in FIG. 2) the value is small. Thus, the preceding vehicle V1 reaches the reference lateral position TH1 quickly.

In the present embodiment, when the relative lateral speed of the preceding vehicle V1 is equal to or lower than the predetermined lower limit threshold TH2, the vehicle traveling control device 100 does not perform control of the traveling of the own vehicle V with determination and interruption of the interrupt of the preceding vehicle V1. Therefore, the reference position setting unit 13, when the lateral relative speed of the preceding vehicle V1 is equal to or less than the lower limit threshold TH2, does not perform the setting of the reference lateral position TH1.

Furthermore, the reference position setting unit 13 sets the reference lateral position TH1 to the side farther from the own vehicle V in the lane lateral direction as the relative speed in the lane longitudinal direction of the preceding vehicle V1 with respect to the own vehicle V calculated by the speed calculating unit 12 is smaller. Here, the reference position setting unit 13, in the coordinate system with the lane separation line K as the origin as shown in FIG. 2, the smaller the relative speed of the preceding vehicle V1, the smaller the value is set the reference lateral position TH1 to the side (left in FIG. 2). Thus, the preceding vehicle V1 reaches the reference lateral position TH1 quickly.

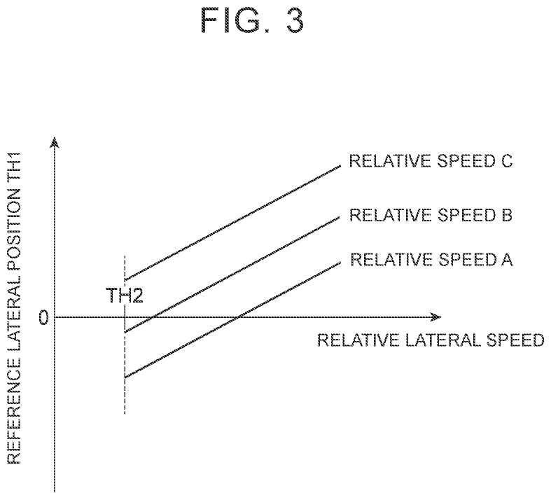

Here, the relation between the relative lateral speed with the preceding vehicle V1 and the relative speed in the longitudinal direction of the lane and the reference lateral position TH1 is shown in FIG. 3. The relative speed A to C shown in FIG. 3 has the smallest value for relative speed A and the largest value for relative speed C. In the present embodiment, the speed of the own vehicle V is higher than that of the preceding vehicle V1. Therefore, the relative speeds A to C have negative values. That is, the speed at which the own vehicle V approaches the preceding vehicle V1 is faster than when the relative speed A is the relative speed C.

For example, as shown in FIG. 3, based on the line of relative speed and the value of the relative lateral speed, the reference lateral position TH1 is set. The reference lateral position TH1 decreases as the relative lateral speed decreases. The reference lateral position TH1 becomes larger as the relative lateral speed increases. That is, the reference lateral position TH1 in FIG. 2 is set to the left side (negative side) as the relative lateral speed decreases. On the other hand, the reference lateral position TH1 in FIG. 2 is set to the right side (positive side) as the relative lateral speed increases. Further, as shown in FIG. 3, the reference lateral position TH1 becomes smaller as the relative speed in the longitudinal direction of the lane becomes smaller. The reference lateral position TH1 increases as the relative speed increases. That is, the reference lateral position TH1 in FIG. 2 is set to the left side (negative side) as the relative lateral speed decreases. The reference lateral position TH1 is set to the right side (positive side) as the relative speed increases.

In the present embodiment, when the relative lateral speed is equal to or less than the lower limit threshold TH2, the determination of the interrupt of the preceding vehicle V1 is not performed. For this reason, in FIG. 3, the lines of the relative speeds A to C are not shown in the portions below the lower limit threshold TH2.

Vehicle control unit 14, by controlling the traveling of the own vehicle V, performs driving support of the own vehicle V. In the present embodiment, the vehicle control unit 14 can provide driving support to an interrupt of the preceding vehicle V1. More particularly, the vehicle control unit 14 determines whether the preceding vehicle V1 has reached the reference lateral position TH1. That is, the vehicle control unit 14 determines whether the preceding vehicle V1 is interrupted in front of the own vehicle V. When the preceding vehicle V1 reaches the reference lateral position TH1 (when the vehicle control unit 14 determines that the preceding vehicle V1 is interrupted in front of the own vehicle V), the vehicle control unit 14 controls the traveling of the own vehicle V so that the lane longitudinal distance between the preceding vehicle V1 and the own vehicle V is secured.

For example, the vehicle control unit 14, when a part of the preceding vehicle V1 overlaps the reference lateral position TH1, it can be determined that the preceding vehicle V1 has reached the reference lateral position TH1. In the example shown in FIG. 2, when the right end of the preceding vehicle V1 reaches the reference lateral position TH1, it can be determined that the preceding vehicle V1 has reached the reference lateral position TH1.

In this instance, the vehicle control unit 14 can determine whether or not the vehicle has reached the reference lateral position TH1 by using the coordinate system having the lane separation line K as the origin. Specifically, the front situation recognition unit 11, as shown in FIG. 2, calculates the distance VL from the lane separation line K which is the origin to the preceding vehicle V1. The distance VL is a distance between an end of the preceding vehicle V1 on the side closer to the own vehicle V and the lane separation line K. Incidentally, the distance VL becomes a positive value when the end portion of the preceding vehicle V1 close to the own vehicle V is located in the own lane L. The distance VL becomes a negative value when the end of the preceding vehicle V1 on the side close to the own vehicle V is located in the adjacent lane L1. That is, in the example shown in FIG. 2, the distance VL has a negative value. Vehicle control unit 14, when the distance VL calculated by the front situation recognition unit 11 is larger than the reference lateral position TH1, it can be determined that the preceding vehicle V1 has reached the reference lateral position TH1.

Further, in the present embodiment, the vehicle control unit 14 performs control to decelerate the own vehicle V in order to secure the vehicle-to-vehicle distance in the longitudinal direction of the lane between the preceding vehicle V1 and the own vehicle V. By decelerating the own vehicle V, the vehicle-to-vehicle distance is ensured as compared with the case where the own vehicle V is not decelerated when the preceding vehicle V1 can be interrupted in front of the own vehicle V. Vehicle control unit 14, by issuing an instruction to the actuator 2, it is possible to reduce the speed of the own vehicle V.

Further, the vehicle control unit 14 sets the reduction amount when decelerating the own vehicle V, it is possible to decelerate the own vehicle V based on the reduction amount set. Here, the vehicle control unit 14 can set the deceleration amount of the own vehicle V based on the vehicle-to-vehicle distance in the lane longitudinal direction between the own vehicle V and the preceding vehicle V1. In this case, the vehicle control unit 14, the shorter the vehicle-to-vehicle distance may be set a large reduction amount. Further, the vehicle control unit 14 can set the deceleration amount of the own vehicle V based on the relative speed in the longitudinal direction of the lane between the own vehicle V and the preceding vehicle V1. In this case, the vehicle control unit 14 may set the deceleration amount to be larger as the relative speed is smaller, that is, as the speed of the own vehicle V is higher in the present embodiment. Incidentally, the vehicle control unit 14 may set the deceleration amount of the own vehicle V on the basis of both the inter-vehicle distance in the lane longitudinal direction between the own vehicle V and the preceding vehicle V1 and the relative speed in the lane longitudinal direction between the own vehicle V and the preceding vehicle V1.

Further, as described above, when the relative lateral speed is equal to or less than the lower limit threshold TH2, the vehicle control unit 14 for securing the vehicle-to-vehicle distance to the interrupt of the preceding vehicle V1 is not performed. Vehicle control unit 14 determines whether the relative lateral speed is equal to or less than the lower limit threshold TH2. If the relative lateral speed is greater than the lower limit threshold TH2, the vehicle control unit 14 performs control to ensure the vehicle-to-vehicle distance described above.

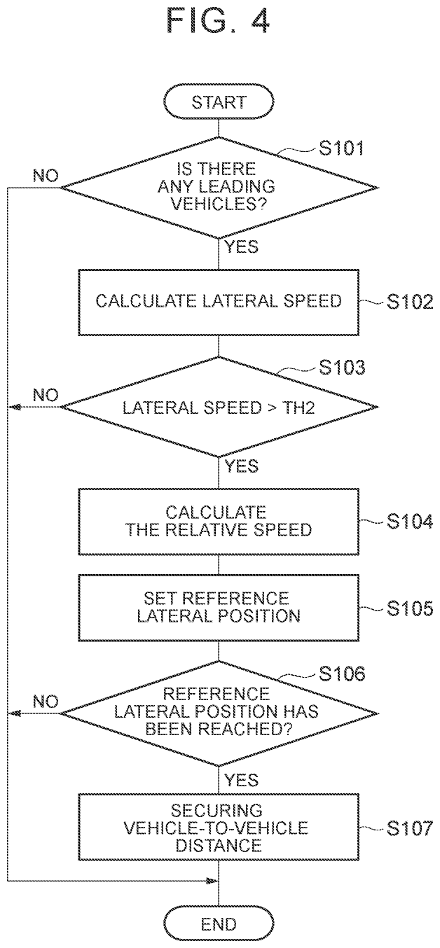

Next, the flow of the processing of the vehicle traveling control method executed in the travel control ECU 10 of the vehicle traveling control device 100 will be described with reference to a flowchart of FIG. 4. That is, this vehicle traveling control method is a control method for ensuring the vehicle-to-vehicle distance between the preceding vehicle V1 and the own vehicle V when the lateral position of the preceding vehicle V1 moves toward the own lane L side and the preceding vehicle V1 reaches the reference lateral position TH1. Incidentally, the process shown in FIG. 4 is executed during the control of the driving support of the own vehicle V by the vehicle traveling control device 100. When the processing reaches the end, the processing is started again after a predetermined period of time from the start.

As shown in FIG. 4, the front situation recognition unit 11 executes a process of recognizing the preceding vehicle V1 traveling in front of the adjacent lane L1 and the own vehicle V (S101). When the preceding vehicle V1 is not present (S101: NO), the travel control ECU 10 starts the process from the start again after a predetermined time. When the preceding vehicle V1 exists (S101: YES), the speed calculating unit 12 calculates the relative lateral speed of the preceding vehicle V1 with respect to the own vehicle V (S102: speed calculation step). Then, the vehicle control unit 14 determines whether or not the calculated relative lateral speed is greater than the lower limit threshold TH2 (S103). If the relative lateral speed is not greater than the lower limit threshold TH2 (S103: NO), the travel control ECU 10 starts the process from the start again after a predetermined time.

When the relative lateral speed is greater than the lower limit threshold TH2 (S103: YES), the speed calculating unit 12 calculates the relative speed of the preceding vehicle V1 with respect to the own vehicle V in the longitudinal direction of the lane (S104: speed calculation step). Then, the reference position setting unit 13 sets the reference lateral position TH1 based on the calculated relative lateral speed and the relative speed in the longitudinal direction of the lane (S105: reference position setting step). Vehicle control unit 14 determines whether the preceding vehicle V1 has reached the set reference lateral position TH1 (S106).

If the reference lateral position TH1 is not reached (S106: NO), the travel control ECU 10 starts the process from the start again after a predetermined time. On the other hand, when the reference lateral position TH1 is reached (S106: YES), the vehicle control unit 14 controls the traveling of the own vehicle V so that the vehicle-to-vehicle distance between the preceding vehicle V1 and the own vehicle V is ensured (S107: vehicle control steps).

As described above, the vehicle traveling control device 100, the smaller the relative lateral speed, the reference lateral position TH1 is set on the far side from the own vehicle V. That is, as the relative lateral speed is smaller, it is determined that the reference lateral position TH1 has been reached at an early stage when the moving amount of the preceding vehicle V1 to the own lane L side is smaller. Thus, even when the relative lateral speed is small, it can be prevented that the vehicle-to-vehicle distance between the preceding vehicle V1 and the own vehicle V already becomes a state of approaching when it is determined that the preceding vehicle V1 is interrupted. Thus, in the vehicle traveling control device 100, based on the lateral relative speed of the preceding vehicle V1, it is possible to determine at an appropriate timing that the preceding vehicle V1 has reached the reference lateral position TH1. Therefore, by using this determination result, in the vehicle traveling control method executed by the vehicle traveling control device 100 and the vehicle traveling control device 100, it is possible to perform control to ensure the vehicle-to-vehicle distance at an appropriate timing based on the traveling state of the preceding vehicle V1.

The reference position setting unit 13 can set the reference lateral position TH1 to the side farther from the preceding vehicle V1 as the relative speed in the lane longitudinal direction of the preceding vehicle V1 with respect to the own vehicle V is smaller. In this case, as the own vehicle V approaches the preceding vehicle V1 earlier, it is determined that the reference lateral position has been reached at an early stage when the amount of movement of the preceding vehicle V1 toward the own lane L side is small. Thus, in the vehicle traveling control device 100, considering the relative speed in the longitudinal direction of the lane with the preceding vehicle V1, it is possible to determine at a more appropriate timing that the preceding vehicle V1 has reached the reference lateral position TH1. Then, based on the determination result, the vehicle traveling control method executed by the vehicle traveling control device 100 and the vehicle traveling control device 100, it is possible to perform control to secure the vehicle-to-vehicle distance at more appropriate timing.

Vehicle control unit 14, as a control for ensuring the vehicle-to-vehicle distance between the preceding vehicle V1 when the preceding vehicle V1 is interrupted, decelerates the own vehicle V. In this case, in the vehicle traveling control method executed by the vehicle traveling control device 100 and the vehicle traveling control device 100, since the own vehicle V can slow the speed approaching the preceding vehicle V1, it is possible to more reliably secure the vehicle-to-vehicle distance between the preceding vehicle V1 and the own vehicle V.

The vehicle control unit 14 sets the deceleration amount on the basis of the longitudinal lane distance between the own vehicle V and the preceding vehicle V1 or the relative speed in the longitudinal lane direction between the own vehicle V and the preceding vehicle V1, and decelerates the own vehicle V on the basis of the set deceleration amount. In this case, in the vehicle traveling control device 100 and the vehicle traveling control method executed by the vehicle traveling control device 100, it is possible to more appropriately decelerate the own vehicle V in accordance with the inter-vehicle distance or the relative speed with respect to the preceding vehicle V1.

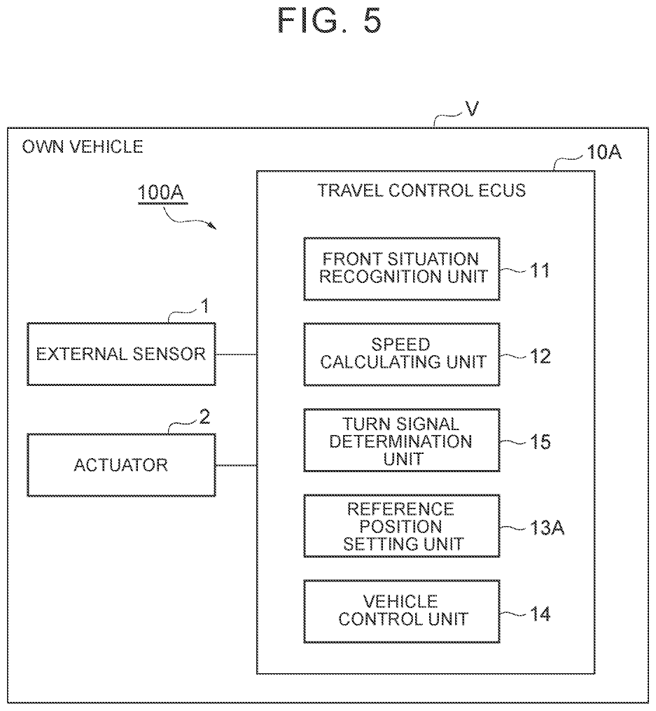

Next, a modification of the vehicle traveling control device 100 described above. As shown in FIG. 5, the vehicle traveling control device 100A according to a modification includes an external sensor 1, an actuator 2, and a travel control ECU 10A. The travel control ECU 10A functionally includes a front situation recognition unit 11, a speed calculating unit 12, a reference position setting unit 13A, a vehicle control unit 14, and a turn signal determination unit 15. Hereinafter, the configuration of the vehicle traveling control device 100A will be described centering on the reference position setting unit 13A and the turn signal determination unit 15, which are different points from the vehicle traveling control device 100 according to the embodiment.

The turn signal determination unit 15 determines whether or not the turn signal of the preceding vehicle V1 traveling in the adjacent lane L1 is actuated. The turn signal determination unit 15, for example, based on the captured image of the camera provided as an external sensor 1, it is possible to determine the presence or absence of operation of the turn signal of the preceding vehicle V1.

The reference position setting unit 13A sets the reference lateral position TH1 in the same manner as the reference position setting unit 13 described above. In this modification, the reference position setting unit 13A further sets the reference lateral position TH1 based on the presence or absence of the operation of the turn signal determined by the turn signal determination unit 15.

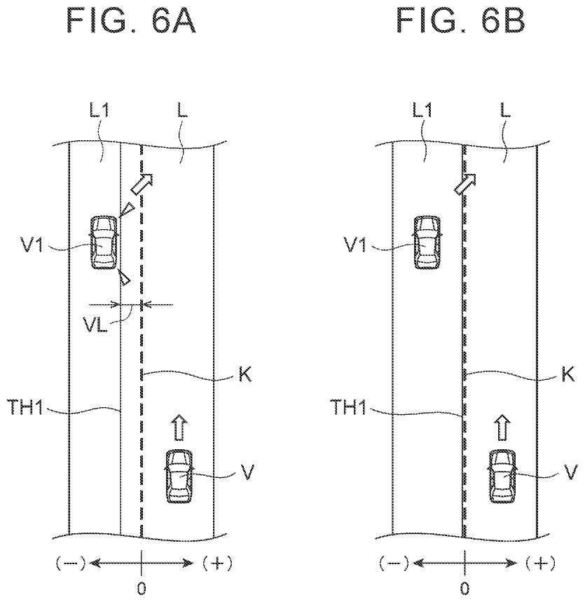

More particularly, as shown in FIG. 6A, when it is determined that the turn signal of the preceding vehicle V1 is operating, similarly to the reference position setting unit 13 described above, the reference position setting unit 13A sets the reference lateral position TH1 on the basis of the relative lateral speed with the preceding vehicle V1 and the relative speed in the lane longitudinal direction. On the other hand, as shown in FIG. 6B, when it is determined that the turn signal of the preceding vehicle V1 is not operating, the reference position setting unit 13A sets the reference lateral position TH1 on the lane separation line K.

For example, as shown in FIG. 6A, if the turn signal of the preceding vehicle V1 is operating, it is believed that the preceding vehicle V1 (the driver of the preceding vehicle V1) is intended to make a lane change. Therefore, similarly to the reference position setting unit 13 described above, the reference position setting unit 13A sets the reference lateral position TH1 on the basis of the relative lateral speed of the preceding vehicle V1 and the relative speed in the lane longitudinal direction.

On the other hand, for example, as shown in FIG. 6B, if the turn signal of the preceding vehicle V1 is not operating, it is believed that the preceding vehicle V1 (the driver of the preceding vehicle V1) is not intended to make a lane change. For this reason, it is considered that the preceding vehicle V1 merely wobbles when the lateral position of the preceding vehicle V1 approaches the own lane L side while the turn signal is not operated. Therefore, the vehicle control unit 14, in order to suppress early determination in which the preceding vehicle V1 cuts in front of the own vehicle, to set the reference lateral position TH1 on the lane separation line K.

In some cases, the preceding vehicle V1 enters into the own lane L even though the winder is not in operation. In this case, at the stage where the preceding vehicle V1 reaches the reference lateral position TH1 set on the lane separation line K, it is determined that the preceding vehicle V1 is interrupted in front of the own vehicle V. Thus, the vehicle traveling control device 100A can control the traveling of the own vehicle V so that the vehicle-to-vehicle distance is secured even when the preceding vehicle V1 is interrupted in front of the own vehicle V even though the turn signal is not operating.

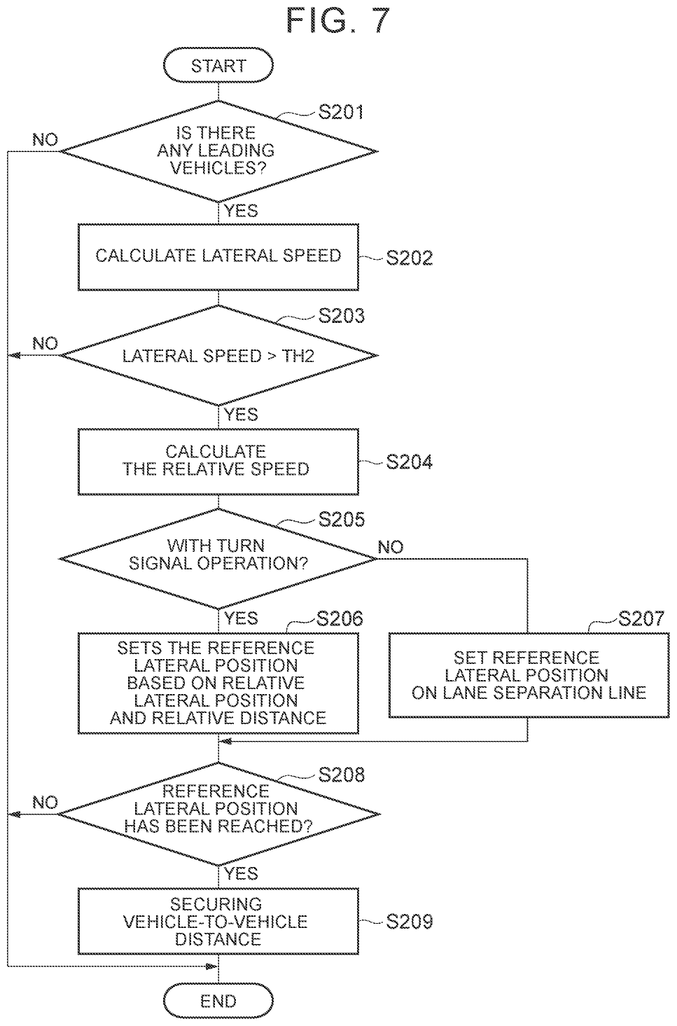

Next, a flow of processing of the vehicle traveling control method executed in the travel control ECU 10A of the vehicle traveling control device 100A will be described with reference to a flow chart of FIG. 7. The processing of S201 to S204 shown in FIG. 7 is the same as the processing of S101 to S104 described with reference to FIG. 4, and a detailed explanation thereof is omitted.

As shown in FIG. 7, after the process of S204, the turn signal determination unit 15 determines whether or not the turn signal of the preceding vehicle V1 is operated (S205: the turn signal determination step). When the winder is in operation (S205: YES), the reference position setting unit 13A sets the reference lateral position TH1 based on the relative lateral speed and the relative speed in the lane longitudinal direction as in S105 shown in FIG. 4 (S206: reference position setting step). On the other hand, if the winder is not in operation (S205: NO), the vehicle control unit 14 sets the reference lateral position TH1 on the lane separation line K (S207: reference position setting step). After the reference lateral position TH1 is set in S206 or S207, the vehicle control unit 14 performs S208 and S209 processing in the same manner as S106 and S107 processing in FIG. 4.

Thus, the vehicle traveling control device 100A according to the modified embodiment sets the reference lateral position TH1 according to the presence or absence of the operation of the turn signal. Here, the vehicle traveling control device 100A sets the reference lateral position TH1 on the lane separation line K when the turn signal of the preceding vehicle V1 is not in operation. Thus, in the vehicle traveling control method performed by the vehicle traveling control device 100A and the vehicle traveling control device 100A, even though the preceding vehicle V1 is only fluctuated, when the preceding vehicle V1 is interrupted in front of the own vehicle V early determination (it is determined that it has reached the reference lateral position) it can be suppressed that. Therefore, in the vehicle traveling control method executed by the vehicle traveling control device 100A and the vehicle traveling control device 100A, the traveling of the own vehicle V can be more appropriately controlled according to the traveling state of the preceding vehicle V1.

While embodiments of the present disclosure have been described above, the present disclosure is not limited to the above embodiments. For example, the speed calculating unit 12 may calculate the lateral speed of the preceding vehicle V1 in the lane lateral direction instead of the relative lateral speed of the preceding vehicle V1. In this case, the reference position setting unit 13 and 13A may set the reference lateral position TH1 to the side farther from the own vehicle V (the negative side in FIG. 2) in the lane lateral direction as the lateral speed of the preceding vehicle V1 is slower. In addition, the speed calculating unit 12 may calculate the speed of the own vehicle V in the longitudinal direction of the lane instead of the relative speed of the preceding vehicle V1 in the longitudinal direction of the lane with respect to the own vehicle V. In this case, the reference position setting unit 13 and 13A may set the reference lateral position TH1 to the side (the negative side in FIG. 2) farther from the own vehicle V in the lane lateral direction as the speed of the own vehicle V in the lane longitudinal direction is higher. Even in these cases, the vehicle traveling control device 100, 100A and the vehicle traveling control method to be executed in these, it is possible to determine at more appropriate timing that the preceding vehicle V1 has reached the reference lateral position TH1, to perform control to ensure the vehicle-to-vehicle distance. The present disclosure may be applied to an autonomous driving vehicle.

What is claimed is:

1. A vehicle traveling control device that performs control for securing a vehicle-to-vehicle distance between a preceding vehicle and an own vehicle when a lateral position of the preceding vehicle traveling in an adjacent lane of an own lane in which the own vehicle travels moves toward the own lane side and the preceding vehicle reaches a predetermined reference lateral position, the vehicle traveling control device comprising:
a speed calculating unit for calculating a lateral speed of the preceding vehicle in a lane lateral direction or a relative lateral speed of the preceding vehicle relative to the own vehicle in the lane lateral direction;
a reference position setting unit for setting the reference lateral position based on the lateral speed or the relative lateral speed calculated by the speed calculating unit; and
a vehicle control unit for controlling traveling of the own vehicle such that the vehicle-to-vehicle distance between the preceding vehicle and the own vehicle in a lane longitudinal direction is secured when the preceding vehicle reaches the reference lateral position,
wherein the reference position setting unit sets the reference lateral position to a side farther from the own vehicle in the lane lateral direction as the lateral speed is lower or the relative lateral speed is smaller.

2. The vehicle traveling control device according to claim 1, wherein:
the speed calculating unit further calculates a speed of the own vehicle in the lane longitudinal direction or a relative speed of the preceding vehicle relative to the own vehicle in the lane longitudinal direction; and
the reference position setting unit sets the reference lateral position to the side farther from the own vehicle in the lane lateral direction as the speed of the own vehicle in the lane longitudinal direction calculated by the speed calculating unit is higher or as the relative speed of the preceding vehicle relative to the own vehicle in the lane longitudinal direction is smaller.

3. The vehicle traveling control device according to claim 1, wherein the vehicle control unit performs control for decelerating the own vehicle such that the vehicle-to-vehicle distance between the preceding vehicle and the own vehicle in the lane longitudinal direction is secured.

4. The vehicle traveling control device according to claim 3, wherein the vehicle control unit sets a deceleration amount of the own vehicle based on the vehicle-to-vehicle distance between the own vehicle and the preceding vehicle in the lane longitudinal direction or the relative speed between the own vehicle and the preceding vehicle in the lane longitudinal direction, and decelerates the own vehicle based on the set deceleration amount.

5. The vehicle traveling control device according to claim 1, further comprising a turn signal determination unit for determining whether a turn signal of the preceding vehicle is operated,
wherein the reference position setting unit sets the reference lateral position on a lane separation line for separating the own lane and the adjacent lane when the turn signal determination unit determines that the turn signal of the preceding vehicle is not operated.

6. A vehicle traveling control method executed in a vehicle traveling control device that performs control for securing a vehicle-to-vehicle distance between a preceding vehicle and an own vehicle when a lateral position of the preceding vehicle traveling in an adjacent lane of an own lane in which the own vehicle travels moves toward the own lane side and the preceding vehicle reaches a predetermined reference lateral position, the vehicle traveling control method comprising:
a speed calculation step of calculating a lateral speed of the preceding vehicle in a lane lateral direction or a relative lateral speed of the preceding vehicle relative to the own vehicle in the lane lateral direction;
a reference position setting step of setting the reference lateral position based on the lateral speed or the relative lateral speed calculated in the speed calculation step; and
a vehicle control step of controlling traveling of the own vehicle such that the vehicle-to-vehicle distance between the preceding vehicle and the own vehicle in a lane longitudinal direction is secured when the preceding vehicle reaches the reference lateral position,
wherein in the reference position setting step, the reference lateral position is set to a side farther from the own vehicle in the lane lateral direction as the lateral speed is lower or the relative lateral speed is smaller.

7. The vehicle traveling control method according to claim 6, wherein:
in the speed calculation step, a speed of the own vehicle in the lane longitudinal direction or a relative speed of the preceding vehicle relative to the own vehicle in the lane longitudinal direction is further calculated; and
in the reference position setting step, the reference lateral position is set to the side farther from the own vehicle in the lane lateral direction as the speed of the own vehicle in the lane longitudinal direction calculated in the speed calculation step is higher or as the relative speed of the preceding vehicle relative to the own vehicle in the lane longitudinal direction is smaller.

8. The vehicle traveling control method according to claim 6, wherein in the vehicle control step, control for decelerating the own vehicle is performed such that the vehicle-to-vehicle distance between the preceding vehicle and the own vehicle in the lane longitudinal direction is secured.

9. The vehicle traveling control method according to claim 8, wherein in the vehicle control step, a deceleration amount of the own vehicle is set based on the vehicle-to-vehicle distance between the own vehicle and the preceding vehicle in the lane longitudinal direction or the relative speed between the own vehicle and the preceding vehicle in the lane longitudinal direction, and the own vehicle is decelerated based on the set deceleration amount.

10. The vehicle traveling control method according to claim 6, further comprising a turn signal determination step of determining whether a turn signal of the preceding vehicle is operated,
wherein in the reference position setting step, the reference lateral position is set on a lane separation line for separating the own lane and the adjacent lane when determination is made in the turn signal determination step that the turn signal of the preceding vehicle is not operated.
